(19) United States
(12) Patent Application Publication
(10) Pub. No.: US 2013/0043218 A1
(43) Pub. Date: Feb. 21, 2013

(54) MULTI-WIRE CUTTING FOR EFFICIENT MAGNET MACHINING

(71) Applicants: Simon Regis Louis Lancaster-Larocque, Gloucester (CA); Ryan Masato Satcher, San Jose, CA (US)

(72) Inventors: Simon Regis Louis Lancaster-Larocque, Gloucester (CA); Ryan Masato Satcher, San Jose, CA (US)

(73) Assignee: Apple Inc., Cupertino, CA (US)

(21) Appl. No.: 13/213,481

(22) Filed: Aug. 19, 2011

(51) Int. Cl. B23H 1/00; B26D 1/547

(52) U.S. Cl. 219/69.17; 219/69.11; 83/651.1; 83/523

(57) ABSTRACT

Methods and apparatus for rapidly and efficiently machining rare earth magnets are disclosed. In particular various embodiments of multi-wire electrical discharge machining and wire saw machines are described that can allow for significant time savings, thereby allowing integration of a wire cutting process into a high volume production scale operation.

### BACKGROUND

1. Field of the Described Embodiments

The described embodiments relate generally to manufacturing methods for cutting magnets. In particular methods for rapidly and efficiently cutting rare earth magnets are disclosed.

2. Related Art

Magnets have been conventionally cut and shaped using diamond coated discs of roughly 0.3-0.4 mm in width. This results in a cut of roughly the same width as that of the disc, resulting in a certain amount of wasted material known as kerf. The recent proliferation of magnets into consumer devices has resulted in a high demand for magnets of smaller size. In applications where magnets are cut as small as 0.8 mm in size a kirf size of even 0.3 mm can result in more than a quarter of the raw material. Unfortunately the rising cost of rare earth magnet raw materials has made waste of such material highly undesirable. Use of the diamond coated discs also results in a rather coarse surface roughness which adds additional finishing steps to the manufacturing process, which in turn wastes even more material.

Wire electrical discharge machining (WEDM) has a number of advantages over conventional cutting methods. In WEDM a wire is continuously fed across a set of electrical contacts. The electrical contacts feed an amount of electricity sufficient to cut through a workpiece through the portion of the wire between the electrical contacts. The voltage and current of the electricity is alternated so as to prevent electrolysis effects across the entire submerged surface of the workpiece. This allows for targeted, precise removal of materials. A working fluid is also required to keep the wire and the workpiece cool, as well as to flush away the removed material. Because wires with diameters as small as 0.1-0.2 mm can be used, the amount of waste material is greatly reduced. Use of small diameter wires can result in a cut size, or kirf of roughly 0.12-0.22 mm. As should be appreciated by cutting the kirf roughly in half, the amount of waste material can also be cut in half. Another advantage of WEDM is that it can produce finished cuts. Unfortunately, WEDM is fairly slow, and when precision cutting is desired cutting speeds as slow as 18-20 inches per hour are quite common. At a cutting speed of 20 inches per hour it would take 75 minutes to put 10 cuts into a 2.5 inch thick magnetic block. This speed limitation has relegated the use of WEDM to applications in which production quantities are relatively low.

Wire saw machines can also be used for making cuts with small kirf size. Wire saw machines can have much the same configuration as WEDM machines since they run wires across a surface of a workpiece to accomplish cutting operations. The primary difference is that wire saw machines use a diamond coated wire to abrasively cut a workpiece, whereas the WEDM machine wires don't touch the workpiece at all since it relies on electrical sparking. Since electrical sparking does not take place in the wire saw machining method an occasional lapse in working fluid does not typically result in wire breakage. Although wire saw machines run slightly faster than WEDM machines, it is still a rather slow time consuming machining process. Unfortunately, the minimum kirf size tends to run a little bigger than with WEDM.

Therefore what is desired is a method for quickly cutting magnets with a minimal amount of waste material.

### SUMMARY OF THE DESCRIBED EMBODIMENTS

This paper describes many embodiments that relate to a method, apparatus, and computer readable medium for efficiently cutting a workpiece with a multi-wire cutting machine.

A method for cutting a workpiece into a plurality of pieces is disclosed. The method includes the following steps: (1) receiving a first workpiece; (2) fixing the first workpiece to a workpiece holder; (3) in a first cutting operation, simultaneously cutting the first workpiece in a first direction with a plurality of wires, wherein at least some of the plurality of wires are aligned anti-parallel with others of the plurality of wires; (4) replacing the first workpiece with a second workpiece; and (5) in a second cutting operation, simultaneously cutting the second workpiece in a second direction with the plurality of wires.

A multi-wire electrical discharge machining (EDM) device is disclosed. The multi-wire EDM device includes the following: (1) a wire spool; (2) a plurality of wires, wherein the plurality of wires are oriented in at least two different directions, anti-parallel wires being vertically separated; (3) a slotted workpiece holder, wherein each of the plurality of wires has a slot in the slotted workpiece holder arranged to receive it; and (4) a working fluid application mechanism, wherein the working fluid application mechanism continuously immerses the portions of the plurality of wires that are in close proximity to the workpiece.

A multi-wire wire saw machine is disclosed. The multi-wire wire saw includes the following: (1) a wire spool; (2) a plurality of abrasively coated wires, wherein the plurality of wires are oriented in at least two different directions, the wires oriented in different directions having enough vertical separation to prevent contact; (3) a slotted workpiece holder, wherein each of the plurality of wires has a corresponding slot in the slotted workpiece holder arranged to receive it; and (4) a plurality of nozzles for cooling the plurality of abrasively coated wires during cutting operations, wherein there is at least one nozzle for each side of each set of parallel abrasively coated wires.

A non-transitory computer readable medium for storing computer instructions executed by a processor in a computer numerical control component of a wire cutting machine for machining a workpiece is disclosed. The non-transitory computer readable medium includes the following: (1) computer code for controlling wire spooling rate, wire cutting speed, and wire path of a plurality of cutting wires; (2) computer code for moving a workpiece holder in at least two axes, the multi-axis movement for machining complex shapes out of the workpiece; (3) computer code for managing the flow of working fluid over the plurality of cutting wires; and (4) computer code for pausing a cutting operation after a first cut is made so that a second workpiece can be substituted for the first workpiece.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 shows a simplified example of single wire EDM.

FIG. 2 shows single wire EDM with nozzle supplied working fluid.

FIGS. 3A and 3B show multi-wire EDM configurations in accordance with one of the described embodiments.

FIGS. 4A, 4B, and 4C show cross-hatched multi-wire EDM configurations in accordance with one of the described embodiments.

FIG. 5 shows how cross-hatched multi-wire EDM can be used to cut away oxidation formed on the outside of a workpiece in accordance with the described embodiments.

FIG. 6 shows a workpiece holder securing a workpiece from above just before the workpiece would be lowered into an immersion tank.

FIG. 7 shows a flowchart describing a method for cutting a workpiece into a number of pieces.

FIG. 8 shows a cross-hatched multi-wire EDM configuration can be used to cut circular pieces out of a workpiece.

### DETAILED DESCRIPTION OF EXAMPLE EMBODIMENTS

Representative applications of methods according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Permanent magnets made of rare earth elements are the strongest type of permanent magnets and have significant advantages over ferrite or alnico magnets. Currently the strongest type of rare earth magnet is made from a sintered Neodymium alloy including Neodymium, Cobalt and Boron. Neodymium magnets have replaced other types of magnets in many applications in modern products that require strong permanent magnets, such as motors in cordless tools, hard disk drives, and magnetic fasteners. Unfortunately, the cost of rare earth elements has increased to the point where any unnecessary waste is highly undesirable. Therefore, manufacturing methods which result in waste of rare earth magnets are being closely scrutinized.

Wire-electrical discharge machining (WEDM) methods can be considerably more efficient at conserving materials than conventional cutting methods. In WEDM a wire is continuously fed across a set of electrodes. The electrodes feed an amount of electricity sufficient to melt a workpiece through the portion of the wire between the electrodes. The voltage and current of the electricity is alternated so as to prevent electrolysis from causing wide spread damage to the surface of the workpiece. The alternating current causes sparks between the workpiece and the wire; each spark generated has enough energy to melt or vaporize small portions of both the workpiece and the wire. A working fluid submerses or is continuously sprayed over the electrified wire portion, keeping it cool and flushing away the melted waste material. Because wires with diameters as small as 0.1-0.2 mm can be used, the amount of waste material is kept to a minimum. The narrow wire diameter results in a cut size, or kirf of about 0.12-0.22 mm in width since the wire removes material from the sides as it moves through the workpiece as well as directly below it. As should be appreciated, since the kirf size can be about half the size of other cutting methods the amount of waste material can also be cut in half. Another advantage of WEDM is that it can produce finished cuts. By varying the parameters surface roughness can be radically reduced when compared to the surface finish of the diamond coated discs. Unfortunately WEDM is fairly slow, and when precision cutting is desired cutting speeds as slow as 18-20 inches per hour are quite common. At a cutting speed of 20 inches per hour it would take 75 minutes to put 10 cuts into a 2.5 inch thick magnetic block. Part of the problem is that most configurations only have one wire running at a time. Although multi-wire EDM systems have been implemented to cut silicone wafers there has been no similar effort directed at using the technology to cut rare earth magnets. By using a multi-wire EDM system many cuts can be made simultaneously, thereby significantly reducing the cutting times mentioned above.

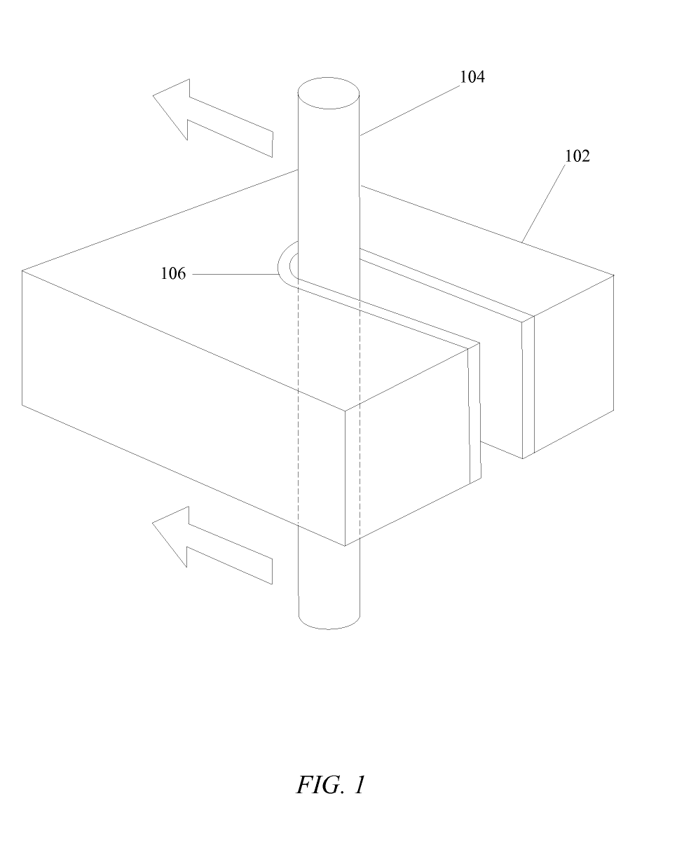

FIG. 1 shows a basic example of single wire EDM. In this illustration only workpiece 102 and wire 104 are shown. Spooling reels, wire guides, water jets and conductivity pieces have been removed for simplicity. In FIG. 1 wire 104 has already cut through a portion of workpiece 102. Wire 104 can be made from a number of different materials. Brass is the most common material used for wire 104 throughout the industry, but the use of brass generally results in relatively thick wires, which create a kirf about as thick as those created by diamond cutting tools. By using a copper coated steel wire a much smaller diameter wire can be used of between 0.1 and 0.2 mm. The copper coating helps keep the wire cool by melting during the WEDM process, which removes energy from the steel wire, keeping it cooler for longer. Wire 104 need not and should not come in contact with workpiece 102. This has the advantage of causing no mechanical stress to the workpiece as the cutting occurs. This is especially advantageous when cutting through extremely brittle materials such as ceramics or rare earth magnets. As can be seen in FIG. 1 the kirf, or cut out area of the workpiece is slightly larger than the diameter of the wire. This is because as the wire moves through the workpiece voltage applied across the wire causes sparking to occur between the wire and the workpiece. Each spark removes a portion of both workpiece 102 and wire 104. Since the sparking occurs both in front of and to the sides of the wire a kirf width of about 10 to 20 percent larger than the wire diameter is common. One disadvantage of the WEDM process is the creation of heat effected zones. Because a large amount of energy is being dissipated across the wire the workpiece tends to heat up during the cutting process. A heat affected zone is common in many manufacturing processes involving high heat. In WEDM for example the heat affected zones are fairly localized. FIG. 1 shows heat affected zone 106. Heat affected zone 106 can penetrate to a depth of about 0.01-0.02 mm into the surface of the cut as illustrated. The heat affected zone of a magnet would not be able to be magnetized. Even when accounting for the loss of the material associated with the heat affected zone the overall loss of material is still substantially smaller than what is lost with conventional cutting tools.

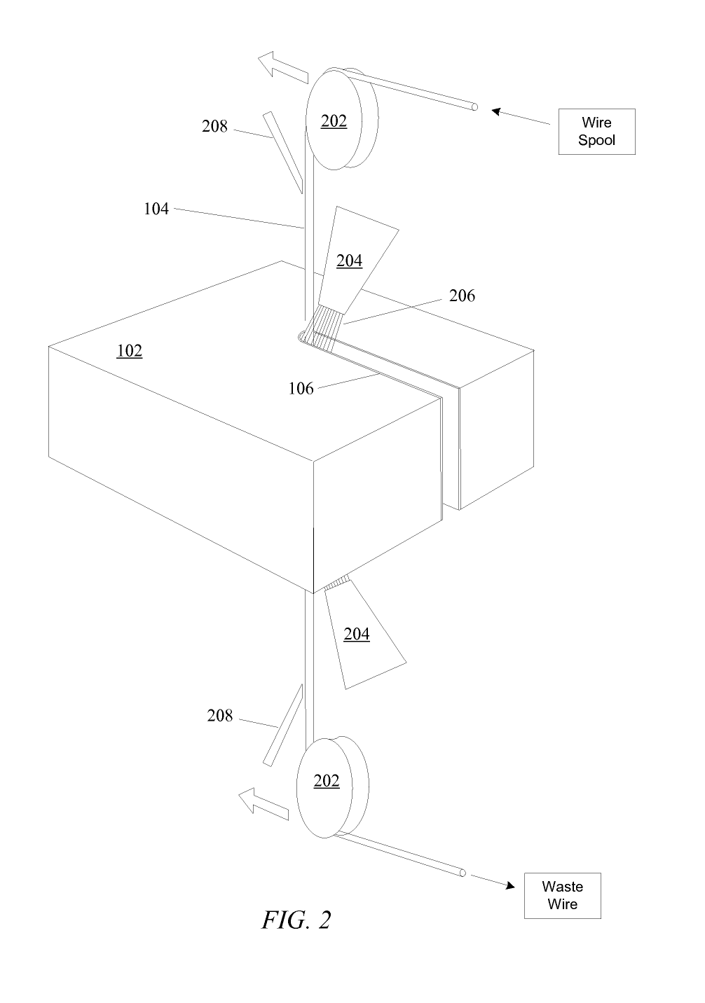

FIG. 2 shows a more detailed diagram of how a WEDM system operates. As already shown workpiece 102 is cut by wire 104. However, as suggested above there are a few more important components in the system. First the wire is so thin that using a wire just held in place with massive amounts of voltage would snap quite quickly due to the material removal. Therefore WEDM systems use wire guides 202 to direct wire 104 from a spool at speeds of up to 600 meters per minute across the surface of workpiece 102. Wire guides 202 can be diamond wire guides with accuracy as tight as about 0.004 mm. Also important to the WEDM process is the use of working fluid to continuously cover wire 104 and to flush out waste material from cutting out the kirf. Nozzles 204 can be placed on either side of the surface of workpiece 102 to keep wire 104 continuously covered with working fluid 206, and to flush waste material away so that waste material is prevented from adhering back to the surface of the workpiece. Working fluid 206 can be deionized water. If wire 104 is not continuously covered any spark between an uncovered portion of the wire and the workpiece will break wire 104 and delay the machining process until the wire can be rethreaded. In another embodiment workpiece 102 and wire 104 could be submerged in a tank of working fluid while the cutting takes place. This is commonly known as immersion WEDM. While this method is quite effective at preventing the wire from becoming uncovered it isn't typically as efficient as the nozzles are at flushing waste material away from the cutting area, since a build of waste around the cutting area can slow down the cutting process. One way to ameliorate the waste build up problem in an immersion tank configuration is to modify the composition of the working fluid, using a hybrid electrolyte with a detergent agent instead of simple deionized water. Finally, conductivity pieces (or electrodes) 208 are used on either side of workpiece 102 to apply voltage across wire 104, thereby concentrating the electrical charge at a portion of wire 104 in contact with workpiece 102.

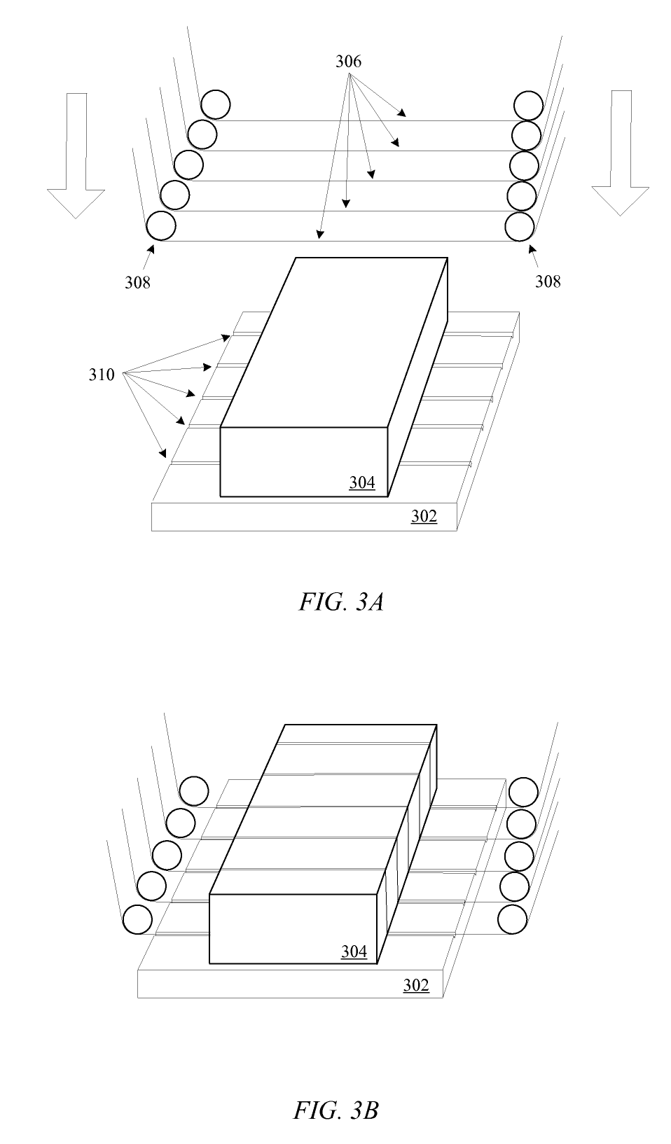

FIG. 3A shows a simplified multi-wire EDM system. A workpiece holder 302 can be arranged to hold workpiece 304. Workpiece 304 can be held firmly in place by workpiece holder 302 in a number of ways including mechanically, with an adhesive, by vacuum suction or even with magnets. Wires 306 are arranged parallel to each other at a pitch distance appropriate for the size of the pieces desired. In this embodiment wire guides 308 descend until just before they contact workpiece 304, at which point the machining begins. By building slots 310 into the bottom of workpiece holder 302, wires 306 can cut all the way through workpiece 304 without doing damage to wires 306 or workpiece holder 302. One especially effective method for holding the magnets in place after the cut occurs is by covering a bottom and side portion of a workpiece in wax or epoxy. The wax can help to hold the pieces of the workpiece together after the wires pass through it. Since the width of the cuts made by the EDM wires is quite narrow the wax can quickly solidify after the EDM wires pass through it, thereby preventing the sliced pieces of the workpiece from separating or toppling. In FIG. 3B wires 306 and associated wire guides 308 are shown after cutting through workpiece 304. WEDM machines generally require wire guides 308 to raise wires 306 back up through workpiece 304. In situations where a follow on finishing cut is required this is quite convenient; however, when the primary purpose of the WEDM use is to conserve material and have an implementation suitable for a manufacturing line this negatively affects both goals. By forcing a second pass machining time can be doubled, and a certain amount of additional valuable material can be removed from workpiece 304. The addition of slots 310 to workpiece holder 302 allows for a continuous machining process. Once the wires descend into slots 310, the power and wire spooling can be abated, thus saving power and wire material. Since the workpiece is still embedded in wax at this point there should be no separation of the small pieces, which can be as small as about 0.8 mm in width. An automated clamping mechanism can then be used to remove the machined workpiece 304. Another workpiece 304 can be moved into position to be cut by the wires as they rise back up again. This effectively maximizes the utility of every cut.

Although as mentioned above multi-wire systems have been used to slice silicon wafers for solar cells, the implementation for cutting magnets is much different. First, silicon wafers are sliced much thinner than the magnets described in this embodiment. In some cases silicon wafers are sliced to a thickness of 0.1 mm. In one set of multi-wire test runs immersion WEDM was required to satisfactorily cut a 0.1 mm thick wafer. Immersion WEDM was required because when working fluid was applied with nozzles, surface tension between the tightly spaced wire electrodes disturbed the consistency of the cuts too much. Magnets are generally cut to thicker widths, typically of at least 0.8 mm. This wider width allows the wire pitch to be wide enough to avoid the surface tension issues experience with wafer slicing; however the wires are still generally too close together to allow enough spacing to place individual nozzles for each wire. Instead of employing individual nozzles to each wire a waterfall effect can be created. Essentially the waterfall effect is created by having a wide width nozzle that can be directed across a number of wires simultaneously. By employing the waterfall effect closely spaced wires can be effectively covered by a single nozzle. The continuous flow of water created by the waterfall also functions to keep waste material flushed away from the cutting area, and that rapid removal of material allows for maintaining a consistent cutting speed across the entire cut.

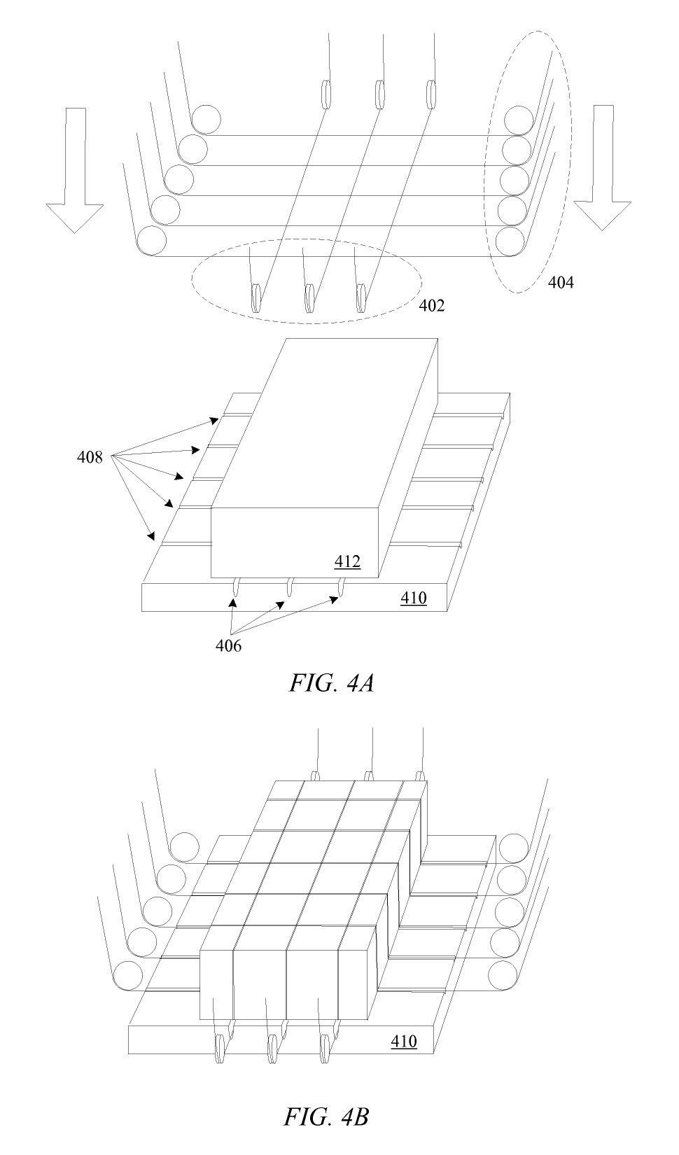

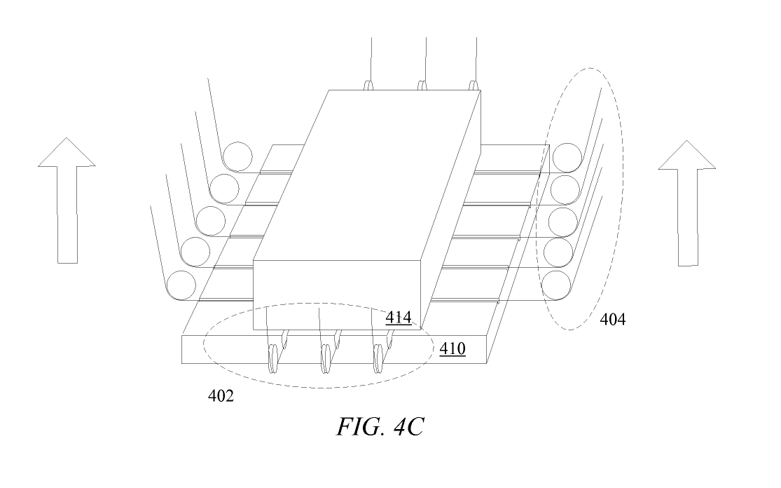

FIG. 4A shows a cross-hatched configuration for WEDM use. When cutting is required in more than one direction, the configuration illustrated in FIGS. 3A and 3B require the workpiece to be reoriented for a second cut. In the cross-hatched configuration illustrated in FIG. 4A parallel WEDM wires 402 are arranged at 90 degree angles with respect to parallel WEDM wires 404. This allows WEDM wires 404 to follow WEDM wires 402 at a close distance, essentially removing the time normally required to reorient the workpiece and perform a second cut. Adding deep slots 406 to shallow slots 408 in workpiece holder 410 provides sufficient separation between the wires after cutting through workpiece.412. After a single cutting pass is performed, the machined workpiece can be vertically lifted off workpiece holder 410. A new workpiece can then be placed on workpiece holder 410 before WEDM wires 402 and 404 travel back up in the opposite direction. FIG. 4B simply illustrates WEDM wires 402 and 404 sitting in workpiece holder 412 after a first WEDM cutting process is complete. After the first cutting operation is complete workpiece 412 can be removed, and replaced with workpiece 414, as shown in FIG. 4C. Parallel WEDM wires 402 and 404 can then cut in the opposite direction of the first cut through workpiece 414.

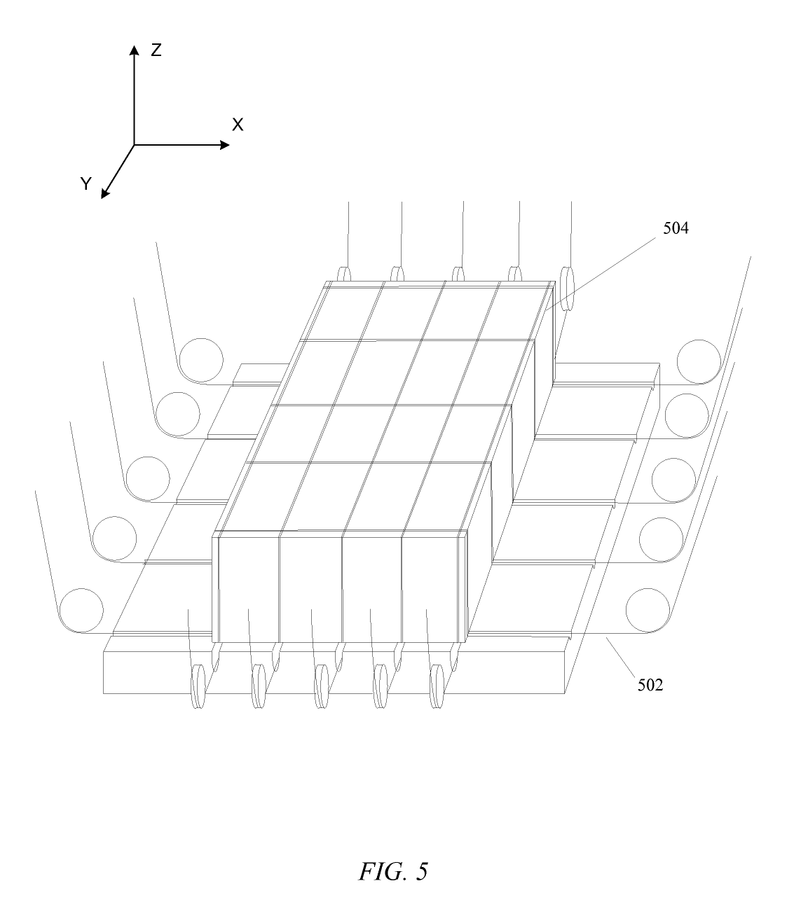

FIG. 5 shows another advantage of using a cross-hatched configuration for cutting magnets. When rare earth magnets are formed the outer portion is susceptible to oxidation. This is why rare earth magnets are coated after the final shape and finish is achieved. Unfortunately during the production process a layer of oxidation typically forms on the outside of the magnets and must be ground away, adding additional time to the overall manufacturing process. Prior to making any cuts to the workpiece, (in this specific described embodiment demagnetized sintered rare earth magnets) the workpiece must go through a lapping process to make the bottom smooth, so that the workpiece can sit flat on the workpiece holder as the wires pass through it. This process step is known as datuming the workpiece. This step has the additional benefit of effectively removing the oxidation layer from the bottom surface of the workpiece; a two sided lapping machine could simultaneously smooth the top surface as well. After datuming, wires 502, shown in FIG. 5, can be configured to remove a small border layer 504 from the X-Y plane of the workpiece as it machines the workpiece in the Z-axis. Ideally border layer 504 only contains oxidized material that would need to be ground away. The cuts made by the WEDM wires can produce smooth production ready cuts as they slice. So assuming the two sided lapping machine was used on the top and bottom, after a single cutting operation as illustrated, every surface of each cut out magnet can be smooth and ready for production. This allows for the post cutting grinding and tumbling to be skipped, or at least substantially abbreviated. By combining these cost saving methods, WEDM should be able to be implemented as a viable, material saving alternative to diamond cutting.

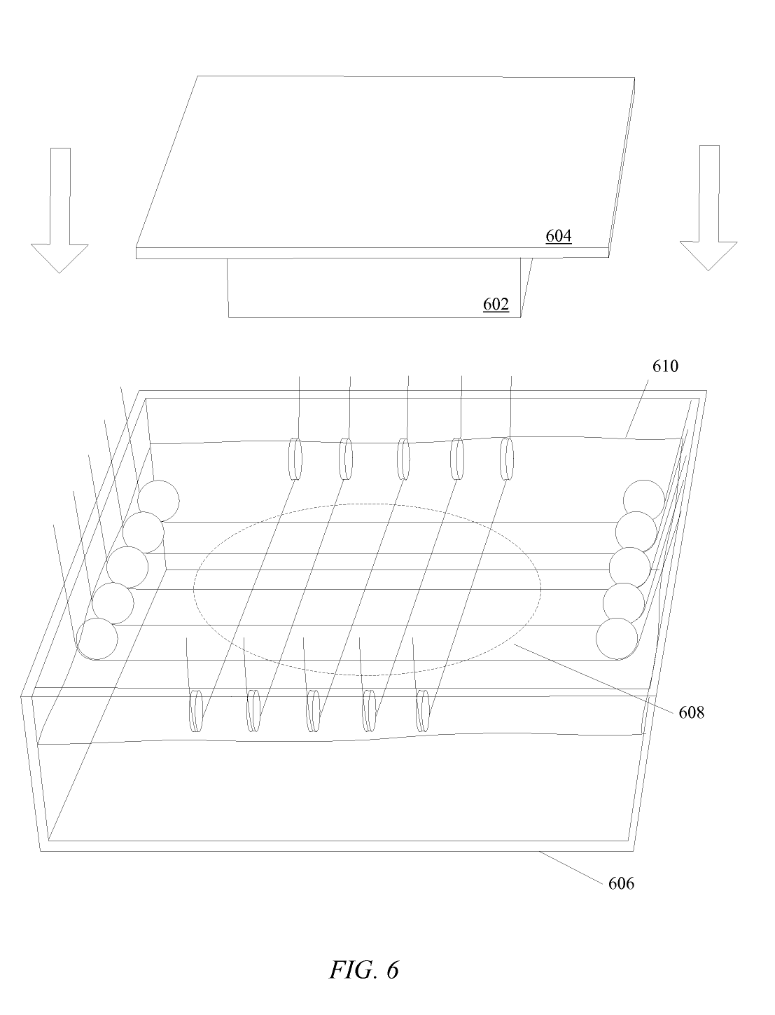

FIG. 6 shows workpiece 602 suspended from an upside down workpiece holder 604. This allows workpiece 602 to be lowered into immersion tank 606 where EDM wires 608 can be positioned far enough below the surface of working fluid 610 to maintain continuous immersion during the cutting process. Grooves are not depicted in workpiece holder 604 since the continuous machining process is impractical with this given configuration; for the continuous method to be employed workpiece 602 would have to be swapped out while inside the immersion tank with workpiece holder 604 above it. Therefore in this configuration WEDM wires 608 can move partially through the wax layer that the workpiece is embedded in before moving back through the workpiece as it is removed from immersion tank 606. This configuration is especially well suited for an immersion configuration since it allows the workpiece to move in and out of the immersion tank without the need for a separate process step where a hand or mechanized picker pulls workpiece 602 out of the immersion tank 606.

The use of a hybrid electrolyte working fluid in immersion tank configurations can also be very beneficial. As mentioned earlier one disadvantage to the immersion tank configuration is that the scrap material isn't flushed away from the cutting area as effectively. This can slow the overall cutting speed of an already time consuming process. The hybrid electrolyte working fluid can include a detergent agent that helps to dissipate the scrap material removed from the workpiece.

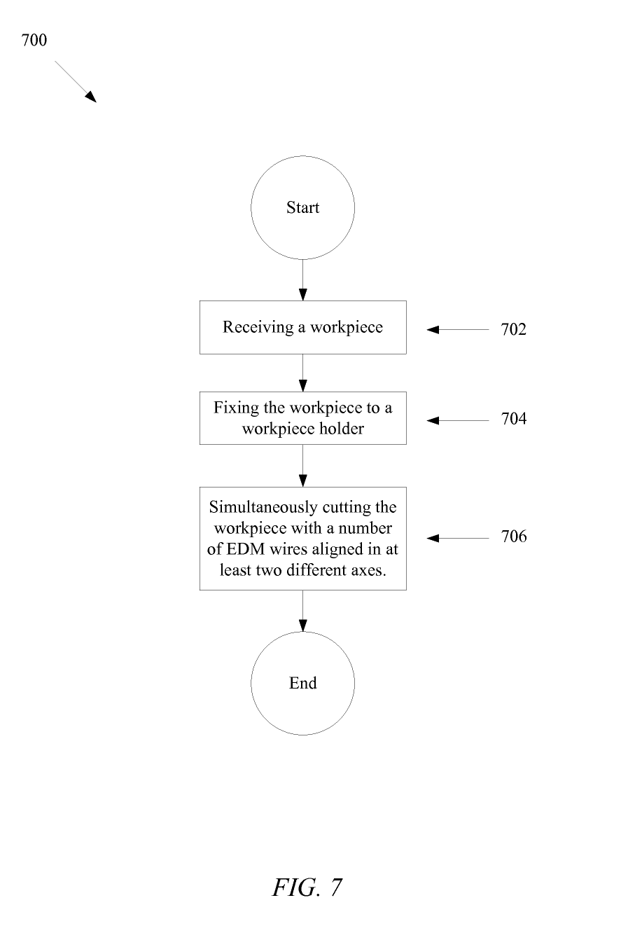

FIG. 7 shows a flowchart 700 describing a method for cutting a workpiece into a number of pieces. In step 702 the workpiece is received. The workpiece can be received from a manufacturing line and placed on a workpiece holder. In step 704 the workpiece is fixed to the workpiece holder. The fixing may be accomplished either mechanically or magnetically. An electro magnet or an electro-permanent magnet could be built into the workpiece holder, allowing the workpiece to be quickly secured and removed in an automated process. In step 706 at least two sets of EDM wires arranged in at least 2 axes. Each set of EDM wires includes a number of EDM wires arranged in parallel. One set of EDM wires is arranged above the other with enough vertical separation to prevent the wires from touching. The EDM wires are then lowered through the workpiece, cutting the workpiece as desired.

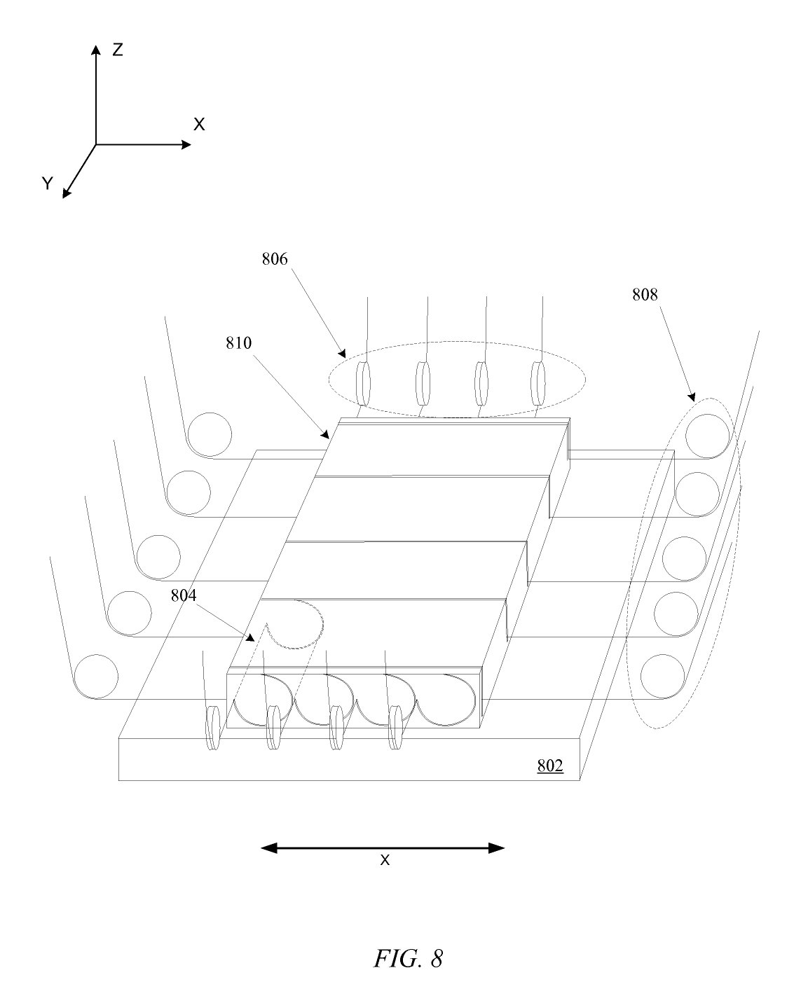

Although the wire configurations of the example embodiments have shown a rectangular workpiece and perpendicular wire directions, the contemplated embodiments extend beyond these examples. For example a circular or oval workpiece could be used. In another alternative embodiment a third or fourth set of wires could be simultaneously lowered through the workpiece, allowing for triangular shapes, or any number of other resulting polygon shapes. Another significant advantage of WEDM is that the wires can be easily maneuvered through the workpiece in a number of different directions. This advantage can be applied in a cross-hatched configured WEDM setup to machine circular magnets. In FIG. 8 a cross-hatched configuration is shown in which workpiece holder 802 has controllers allowing it to maneuver in both the X and Z axes with respect to the wires so it can form a number of magnets shaped like cylindrical magnet 804. WEDM wires 806 are shown having already formed about three quarters of the cylinder shape while WEDM wires 808 are shown having cut the cylinders into the appropriate finished length. WEDM wires 808 trace a straight line through workpiece 810 since in this exemplary described embodiment workpiece 810 is not maneuvered in the Y axis. Although cutting circles out of rectangular blocks does leave more waste material, salvageable material can still be recycled to form new blocks. Again as in previous examples the use of a cross-hatched configuration greatly speeds up the cutting process, and as shown in FIG. 8 is flexible enough to cut out a number of other non-rectangular shapes from workpiece 810.

Another way to minimize kirf size in a machining process is to use narrow wires with a wire saw machine in place of the WEDM cutting machines. Since a wire saw machine can be configured in a very similar manner to that of a WEDM machine, many of the same efficiencies can be achieved with the configurations of the previously described embodiments; the main difference being that the wire saw puts a diamond dusted wire in physical contact with the workpiece for abrasive cutting whereas the WEDM process cuts away material by high energy, localized electrical erosion between an electrified copper coated steel wire and a workpiece. The wire saw machine has an added benefit of being better suited for operating in the previously described waterfall configuration. In the waterfall configuration, portions of the cutting wire can become occasionally uncovered. For example, an air bubble in the nozzle fluid feed line could cause a temporary interruption in water flow resulting in a wire break or other mechanical failures in the WEDM configuration unlike a wire saw wire that would experience only a nominal amount of heating. Although the minimum kirf width is about 50% larger than with WEDM, the wire saw has another advantage in that the heat affected zone is much smaller than the one created in the WEDM process. This leads to a slightly higher quality end product, since more of the magnetic material can be magnetized after the machining process is complete. Moreover, the wire saw machining can benefit greatly from any of the efficiencies described in the previously described WEDM embodiments including: the introduction of the continuous machining process described under FIG. 3; the cross-hatched machining process described in FIG. 4; and the oxidized material trimming process described in FIG. 5.

All of the aforementioned cutting machines generally use computer numerical control (CNC) components to direct the operation of the cutting machine. CNC components built into a cutting machine allow an operator to input a set of designs into a computer coupled to a cutting machine. The computer then has a processor which executes the commands input by the operator, and directs the movement of the cutting machine in a precise and repeatable manner. Although an operator will typically supervise operation of the CNC machines, processes can be set up to execute automatically without any need for human intervention.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, DVDs, magnetic tape, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for cutting a workpiece into a plurality of pieces, the method comprising:
receiving a first workpiece;
fixing the first workpiece to a workpiece holder;
in a first cutting operation, simultaneously cutting the first workpiece in a first direction with a plurality of wires, wherein at least some of the plurality of wires are aligned anti-parallel with others of the plurality of wires;
replacing the first workpiece with a second workpiece immediately after the first cutting operation is complete; and
in a second cutting operation, using the plurality of wires to simultaneously cut the second workpiece in a second direction.

2. The method as recited in claim 1, wherein the second cutting operation occurs immediately after the replacing and wherein the first direction and the second direction are opposite to each other.

3. The method as recited in claim 2, wherein the workpiece is a demagnetized rare earth magnet.

4. The method of claim 3, wherein the first and second cutting operations further comprise:
cutting away oxidized magnetic material from an outer portion of the workpiece.

5. The method as recited in claim 3, wherein a bottom portion of the workpiece is embedded in a wax substrate before the first cutting operation so that the workpiece remains in one piece after the first cutting operation is complete.

6. The method as recited in claim 3, wherein the wires are covered in working fluid by a waterfall system which continuously covers the wires and flushes away waste material.

7. The method as recited in claim 6, wherein the wires are diamond dusted wires from a wire saw machine.

8. The method as recited in claim 3, wherein the wires are immersed in a tank of working fluid during the first and second cutting operations.

9. The method as recited in claim 8, wherein the wires are electronic discharge machining (EDM) wires.

10. A multi-wire electrical discharge machining (EDM) device, comprising:
a wire spool;
a plurality of wires, wherein the plurality of wires are oriented in at least two different directions, anti-parallel wires being vertically separated;
a slotted workpiece holder, wherein each of the plurality of wires has a slot in the slotted workpiece holder arranged to receive it; and
a working fluid application mechanism, wherein the working fluid application mechanism continuously immerses the portions of the plurality of wires that are in close proximity to the workpiece.

11. The multi-wire EDM device as recited in claim 10, wherein the anti-parallel wires are aligned perpendicularly.

12. The multi-wire EDM device as recited in claim 10, wherein the slotted workpiece holder can maneuver in at least two different axes.

13. The multi-wire EDM machine as recited in claim 10, wherein the working fluid application mechanism is an immersion tank.

14. The multi-wire EDM machine as recited in claim 10, wherein the working fluid application mechanism is a plurality of nozzles.

15. A multi-wire wire saw machine, comprising:
a wire spool;
a plurality of abrasively coated wires, wherein the plurality of wires are oriented in at least two different directions, the wires oriented in different directions having enough vertical separation to prevent contact;
a slotted workpiece holder, wherein each of the plurality of wires has a corresponding slot in the slotted workpiece holder arranged to receive it; and
a plurality of nozzles for cooling the plurality of abrasively coated wires during cutting operations, wherein there is at least one nozzle for each side of each set of parallel abrasively coated wires.

16. The multi-wire wire saw machine as recited in claim 15, wherein the abrasively coated wires are impregnated with diamond dust.

17. The multi-wire wire saw machine as recited in claim 16, wherein the abrasively coated wires can be run across the workpiece a number of times before having to be disposed of.

18. A non-transitory computer readable medium for storing computer instructions executed by a processor in a computer numerical control component of a wire cutting machine for machining a workpiece, the non-transitory computer readable medium comprising:
computer code for controlling wire spooling rate, wire cutting speed, and wire path of a plurality of cutting wires;
computer code for moving a workpiece holder in at least two axes, the multi-axis movement for machining complex shapes out of the workpiece;
computer code for managing the flow of working fluid over the plurality of cutting wires; and
computer code for pausing a cutting operation after a first cut is made so that a second workpiece can be substituted for the first workpiece.

19. The non-transitory computer readable medium as recited in claim 18, wherein the non-transitory computer readable medium further comprises:
computer code for setting the distance between at least two anti-parallel sets of the plurality of cutting wires.

20. The non-transitory computer readable medium as recited in claim 19, wherein the non-transitory computer readable medium further comprises:
computer code for applying an alternating current across the plurality of cutting wires.
